(19) United States
(12) Patent Application Publication
(10) Pub. No.: US 2024/0405403 A1
(43) Pub. Date: Dec. 5, 2024

(54) ANTENNA APPARATUS

(71) Applicant: KMW INC., Hwaseong-si, Gyeonggi-do (KR)

(72) Inventors: Sung Hwan SO, Hwaseong-si (KR); Oh Seog CHOI, Hwaseong-si (KR); Seong Man KANG, Hwaseong-si (KR); Yong Won SEO, Daejeon (KR); Yong Sang LEE, Yongin-si (KR); Jun Ho YUN, Suwon-si (KR)

(73) Assignee: KMW INC., Hwaseong-si, Gyeonggi-do (KR)

(21) Appl. No.: 18/805,532

(22) Filed: Aug. 15, 2024

Related U.S. Application Data
(63) Continuation of application No. PCT/KR2023/002173, filed on Feb. 15, 2023.

(30) Foreign Application Priority Data
Feb. 16, 2022 (KR) 10-2022-0020360
Feb. 14, 2023 (KR) 10-2023-0019105

(51) Int. Cl. H01Q 1/02; H01Q 9/04

(52) U.S. Cl. CPC H01Q 1/02; H01Q 9/0407

(57) ABSTRACT

The present invention relates to an antenna apparatus. In particular, the antenna apparatus comprises: a front heat dissipation housing in which at least two antenna arrangement portions are continuously arranged in a horizontal direction (H-direction), the at least two antenna arrangement portions having the at least one radiation element arranged on the front surface thereof; and a rear heat dissipation housing having a front end to which the front heat dissipation housing is coupled, and a plurality of rear heat dissipation pins for discharging predetermined heat in the rearward direction, wherein the front heat dissipation housing is integrally provided with a plurality of front heat dissipation pins for discharging predetermined heat in the forward direction, and some of the plurality of front heat dissipation pins are provided in the form of at least one partition wall that divides between the at least two antenna arrangement portions in the H-direction, thus providing the advantages of improving or maintaining XPD and isolation characteristics and maintaining heat dissipation performance.

### TECHNICAL FIELD

The present disclosure relates to an antenna apparatus, and more particularly, to an antenna apparatus which can improve heat dissipation performance, can be made slim, and can reduce costs for manufacturing a product, by removing the radome of a conventional antenna apparatus and disposing radiation elements in the front housing of the antenna apparatus.

### BACKGROUND ART

A base station antenna including a relay, which is used in a mobile communication system, has various forms and structures. In general, the base station antenna has a structure in which a plurality of radiation elements are properly disposed on at least one reflection plate that stands upright in a length direction thereof.

Active research is recently carried out in order to satisfy a demand for high performance of a multiple input and multiple output (MIMO)-based antenna and to also achieve a small-sized, lightweighting, and low cost structure. In particular, in the case of an antenna apparatus to which a patch type radiation element for implementing linear polarization or circular polarization has been applied, in general, a method of plating the radiation element consisting of a dielectric substrate made of a plastic or ceramic material and coupling the radiation element with a printed circuit board (PCB), etc. through soldering is widely used.

FIG. 1 is an exploded perspective view illustrating an example of an antenna apparatus according to the conventional technology.

In the antenna apparatus 1 according to the conventional technology, as illustrated in FIG. 1, a plurality of radiation elements 35 are output in a desired direction and are arranged to be exposed toward a front surface of an antenna housing main body 10, that is, a beam output direction, so that beamforming is facilitated. A radome 50 is mounted on the front end of the antenna housing main body 10 with the plurality of radiation elements 35 interposed therebetween in order to protect the plurality of radiation elements against an external environment.

More specifically, the antenna apparatus includes the antenna housing main body 10 having a thin rectangular parallelepiped enclosure shape in which the front surface of the antenna housing main body is opened and having a plurality of heat dissipation pins 11 integrally formed on a rear surface thereon, a main board 20 that is stacked and disposed on the rear surface of the antenna housing main body 10 therein, and an antenna board 30 that is stacked and disposed on the front surface of the antenna housing main body 10 therein.

A plurality of feeding-related part elements for calibration feeding control are mounted on the main board 20. Heat of the elements that is generated in a feeding process is discharged backward through the plurality of heat dissipation pins 11 at the rear of the antenna housing main body 10.

Furthermore, a power supply unit (PSU) board 40 on which PSU elements are mounted is stacked or disposed at the same height under the main board 20 or the antenna housing main body 10. Heat that is generated from the PSU elements is also discharged backward through the plurality of heat dissipation pins 11 that are integrally provided at the rear of the antenna housing main body 10 or through PSU heat dissipation pins 16 of a PSU housing 15 that is formed separately from the antenna housing main body 10 and that is attached to the rear surface of the antenna housing main body 10. A plurality of RF filters 25 that are provided in a cavity filter type are disposed on the front surface of the main board 20. A rear surface of the antenna board 30 is disposed to be stacked on a front surface of the plurality of RF filters 25.

The patch type radiation elements or dipole type radiation elements 35 are mounted on a front surface of the antenna board 30. The radome 50 that protects internal parts against the outside and also facilitates radiation from the radiation elements 35 may be installed on the front surface of the antenna housing main body 10.

However, in an example of the antenna apparatus 1 according to the conventional technology, a heat dissipation area is inevitably limited as much as the area of the radome 50 because the front part of the antenna housing main body 10 is shielded by the radome 50. Heat that is generated from the radiation elements 35 is not discharged forward because the radiation elements 35 are also designed to perform only the transmission and reception of an RF signal. Accordingly, there is a problem in that heat dissipation efficiency is greatly degraded because heat that is generated within the antenna housing main body 10 is inevitably uniformly discharged to the rear of the antenna housing main body 10. There is an increasing demand for the design of a new heat dissipation structure for solving such a problem.

Furthermore, the example of the antenna apparatus 1 according to the conventional technology has a problem in that it is very difficult to implement a base station having a slim size, which is required for an in-building or 5G shadow area, due to the volume of the radome 50 and the volume of the structure in which the radiation elements 35 are disposed to be spaced apart from the front surface of the antenna board 30.

### DISCLOSURE

### Technical Problem

The present disclosure has been contrived to solve the technical problems, and an object of the present disclosure is to provide an antenna apparatus having heat dissipation performance greatly improved by removing a radome and disposing radiation elements in a front housing of the antenna apparatus so that both the front housing and rear housing of the antenna apparatus are used for forward and backward heat dissipation.

Furthermore, another object of the present disclosure is to provide an antenna apparatus capable of efficiently transmitting heat within an antenna housing to the front of the antenna apparatus by using a filter as a heat transfer medium.

Furthermore, still another object of the present disclosure is to provide an antenna apparatus capable of easily implementing a base station having a slim size, which is required for an in-building installation or 5G shadow area, by removing a conventional radome so that the front and rear volumes of the radome is removed.

Technical objects of the present disclosure are not limited to the aforementioned objects, and the other objects not described above may be evidently understood from the following description by those skilled in the art.

### Technical Solution

An antenna apparatus according to an embodiment of the present disclosure includes a front heat dissipation housing in which two or more antenna arrangement parts in each of which one or more radiation elements are disposed on a front surface thereof are continuously arranged in a horizontal direction (H direction), and a rear heat dissipation housing having a front end to which the front heat dissipation housing is coupled, and a plurality of rear heat dissipation pins for discharging predetermined heat in the rearward direction. A plurality of front heat dissipation pins that discharge predetermined heat in the forward direction are integrally provided in the front heat dissipation housing. Some of the plurality of front heat dissipation pins are provided in the form of at least one partition wall that partitions the two or more antenna arrangement parts in the H direction.

In this case, a front end of the at least one partition wall may be provided to protrude identically with a front surface of the radiation element from a front surface of the front heat dissipation housing.

Furthermore, a front end of the at least one partition wall may be provided to more forward protrude than a front surface of the radiation element from a front surface of the front heat dissipation housing.

Furthermore, the at least one radiation element may be made of a conductive metal material on an antenna patch circuit part that is printed and formed on a printed circuit board for radiation elements, which is disposed in the antenna arrangement part, and may be provided in the form of a director for radiation that is electrically connected to the antenna patch circuit part. The front end of the at least one partition wall may be provided to more protrude than at least a front surface of the director for radiation.

Furthermore, a plurality of window grooves may be incised and formed in the partition wall so that the plurality of window grooves are opened in the H direction.

Furthermore, the plurality of window grooves may each be formed to be adjacent to the left end and right end of each of the radiation elements.

Furthermore, the incision depth of each of the plurality of window grooves may be differently designed by considering isolation performance measurement values with radiation elements that are adjacent to the window groove in the H direction.

An antenna apparatus according to another embodiment of the present disclosure includes a front heat dissipation housing in which two or more antenna modules are continuously arranged in a horizontal direction (H direction). A plurality of front heat dissipation pins that discharge predetermined heat forward are integrally provided in the front heat dissipation housing. Some of the plurality of front heat dissipation pins are provided in the form of at least one partition wall that partitions the two or more antenna modules in the H direction.

In this case, the antenna module may include an antenna patch circuit part printed and formed on a printed circuit board for radiation elements that is disposed in an antenna arrangement part, an antenna module cover disposed to cover a front surface of the antenna patch circuit part, and a director for radiation disposed on a front surface of the antenna module cover, made of a conductive metal material, and electrically connected to the antenna patch circuit part. The at least one partition wall may be integrally formed in the front heat dissipation housing so that the at least one partition wall partitions the printed circuit boards for radiation elements, among components of the two or more antenna modules that are disposed to be adjacent to each other in the H direction.

Furthermore, a plurality of window grooves may be formed in the partition wall so that the plurality of window grooves are opened in the H direction.

Furthermore, the plurality of window grooves may each be formed at a portion that is close to both left and right ends of the director for radiation.

### Advantageous Effects

According to an embodiment of the antenna apparatus according to the present disclosure, the following various effects can be achieved.

First, there is an effect in that heat dissipation performance is greatly improved because forward and backward heat dissipation of the antenna apparatus is possible by removing a radome, that is, an obstacle to front heat dissipation of an antenna and disposing the radiation elements in the front heat dissipation housing of the antenna apparatus so that the radiation elements are exposed to outside air.

Second, there is an effect in that costs for manufacturing a product are greatly reduced because a radome, that is, an essential component of a conventional antenna apparatus, can be removed.

Third, there is an effect in that heat dissipation performance is greatly improved because system heat within the antenna housing main body can be discharged forward as much as the area of the heat dissipation cover, which is increased due to the removal of the radome.

Fourth, there is an effect in that a slim design for a product is generally easy because full-scale heat dissipation toward the front is possible and thus the length of the heat dissipation pins of the rear heat dissipation housing can be reduced.

Fifth, there is an effect in that the heat dissipation area of the front heat dissipation housing can be maximized because heat can also be discharged through the medium of the director which performs a radiation function for electromagnetic waves in the antenna module.

Sixth, there are effects in that the degradation of isolation performance is minimized and heat dissipation performance can be greatly improved because at least some of the plurality of front heat dissipation pins that are integrally formed on the front surface of the front heat dissipation housing are disposed to partition the radiation elements or the antenna arrangement parts that are continuously disposed in the H direction or to partition the antenna modules.

Effects of the present disclosure are not limited to the aforementioned effects, and the other effects not described above may be evidently understood by those skilled in the art from the claims.

### DESCRIPTION OF DRAWINGS

FIG. 1 is an exploded perspective view illustrating an example of an antenna apparatus according to the conventional technology.

FIG. 2 is a perspective view of a front part of an antenna apparatus according to an embodiment of the present disclosure.

FIGS. 3A and 3B are a front view and rear view of the antenna apparatus according to an embodiment of the present disclosure.

FIG. 4 is an exploded perspective view illustrating an internal space of the antenna apparatus illustrated in FIG. 2.

FIG. 5 is a cross-sectional view taken along line A-A in FIG. 3A and a partially enlarged view thereof.

FIGS. 6A and 6B are front-side and rear-side exploded perspective views illustrating a main board and filters that are stacked in an internal space of a rear heat dissipation housing, among the components of FIG. 2.

FIG. 7 is an exploded perspective view illustrating a direct rear heat dissipation structure through the rear heat dissipation housing, among the components of FIG. 2.

FIGS. 8A and 8B are front-side and rear-side exploded perspective views illustrating a form in which a sub-board and a shield panel, among the components of FIG. 2, have been installed in the main board.

FIG. 9 is an exploded perspective view for describing a form in which a PSU unit, among the components of FIG. 2, is electrically connected to the main board.

FIG. 10 is an exploded perspective view for describing a form in which the filters have been coupled with the main board, among the components of FIG. 2.

FIG. 11 is a partial cutaway perspective view for describing a form in which heat that is generated from the filter is discharged through the medium of the rear heat dissipation housing, among the components of FIG. 2.

FIGS. 12A and 12B are front-side and rear-side exploded perspective views of a process of assembling internal components, among the components of FIG. 2, with the rear heat dissipation housing.

FIG. 13 is an exploded perspective view for describing a process of assembling outside members, among the components of FIG. 2, with the rear heat dissipation housing.

FIG. 14 is a front-side exploded perspective view for describing a form in which an antenna module, among the components of FIG. 2, has been installed in a front heat dissipation housing.

FIG. 15 is a front-side and rear-side exploded perspective view of a form in which the antenna module, among the components of FIG. 14, has been installed on a front surface of the front heat dissipation housing.

FIG. 16 is a perspective view illustrating the antenna module, among the components of FIG. 14.

FIGS. 17A and 17B are front surface-side exploded perspective view and rear surface-side exploded perspective view of FIG. 14.

FIG. 18 is a front view of the antenna module, among the components of FIG. 14, and is a cross-sectional view taken along line B-B and a cutaway perspective view thereof.

FIG. 19 is a perspective view illustrating another embodiment of the antenna module.

FIG. 20 is a perspective view illustrating a modified example of FIG. 19.

FIG. 21 illustrates three surface views (a front view, a side view, and a plane view) in FIG. 20.

FIGS. 22 and 23 are graphs for comparing XPD values and isolation values of the antenna modules in FIGS. 19 and 20.

### DESCRIPTION OF REFERENCE NUMERALS

1: antenna apparatus 100: front heat dissipation housing
110: antenna module 111: antenna module cover
117: director for radiation 118: module installation plate
118w: partition wall 118h: window groove
120: printed circuit board 121: director
122: antenna patch part 124: feeding line
178: director fixing hole 170: antenna arrangement part
105: heat dissipation part 350: filter
180: fixing screw 200: rear heat dissipation housing
210: rear heat dissipation pin 220: main board

### BEST MODE

Hereinafter, an antenna apparatus according to an embodiment of the present disclosure is described in detail with reference to the accompanying drawings.

In adding reference numerals to the components of each drawing, it should be noted that the same components have the same reference numerals as much as possible even if they are displayed in different drawings. Furthermore, in describing embodiments of the present disclosure, when it is determined that a detailed description of the related well-known configuration or function hinders understanding of an embodiment of the present disclosure, the detailed description thereof will be omitted.

In describing components of an embodiment of the present disclosure, terms, such as a first, a second, A, B, (a), and (b), may be used. Such terms are used only to distinguish one component from another component, and the essence, order, or sequence of a corresponding component is not limited by the terms. All terms used herein, including technical or scientific terms, have the same meanings as those commonly understood by a person having ordinary knowledge in the art to which the present disclosure pertains, unless defined otherwise in the specification. Terms, such as those commonly used and defined in dictionaries, should be construed as having the same meanings as those in the context of a related technology, and are not construed as having ideal or excessively formal meanings unless explicitly defined otherwise in the specification.

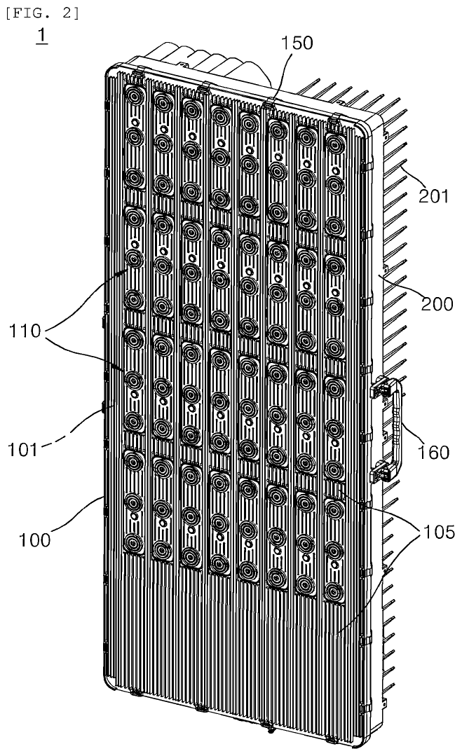

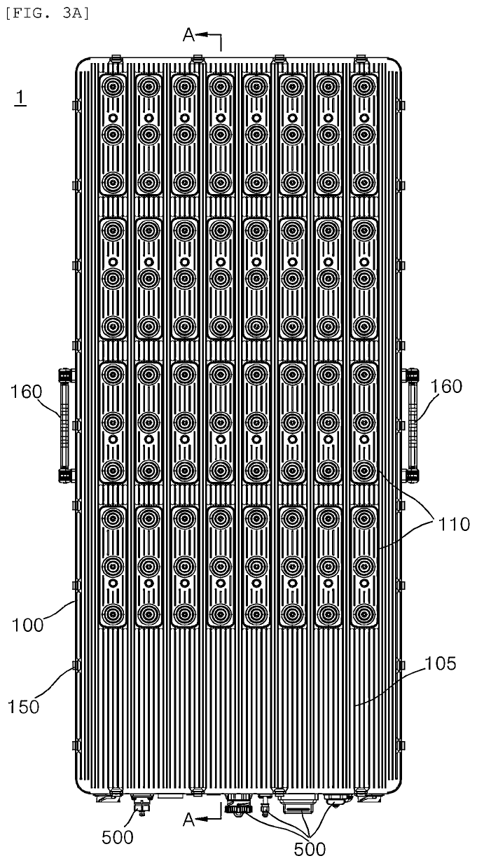

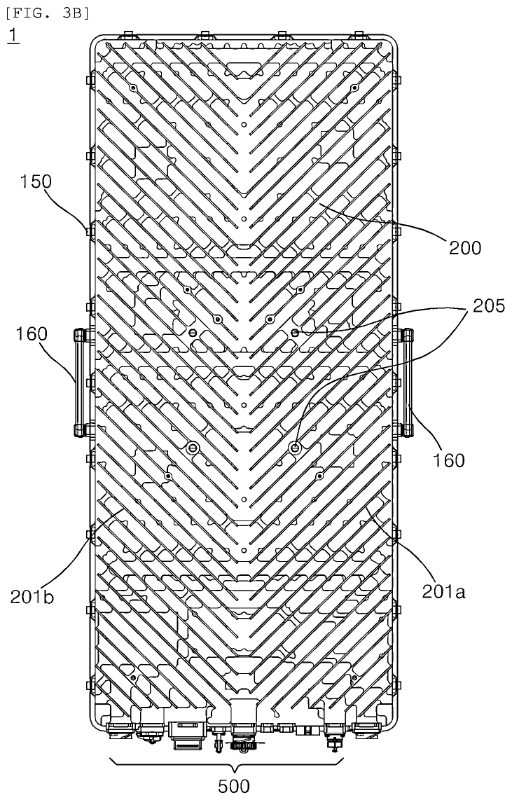

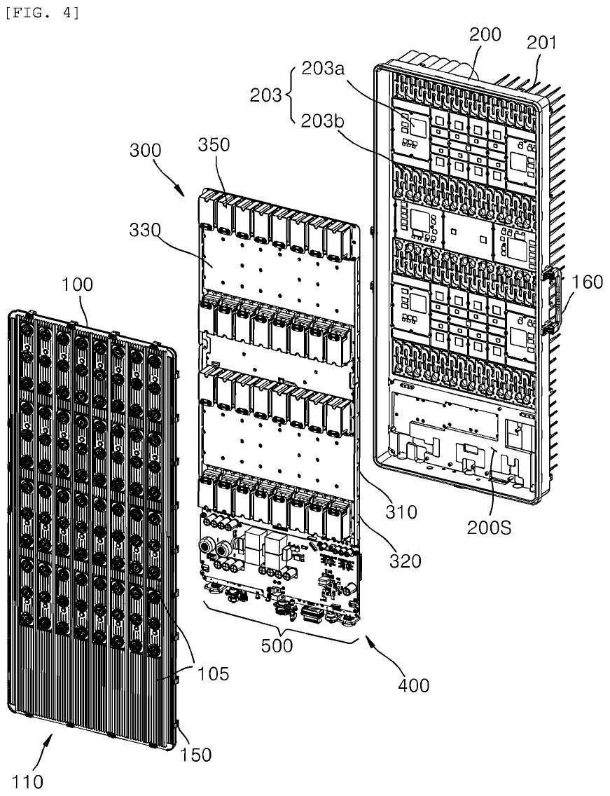

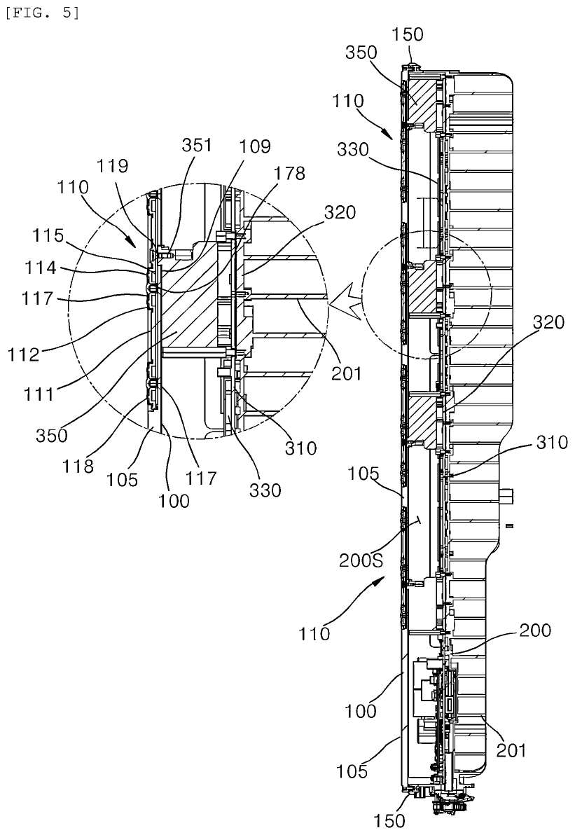

FIG. 2 is a perspective view of a front part of an antenna apparatus according to an embodiment of the present disclosure. FIGS. 3A and 3B are a front view and rear view of the antenna apparatus according to an embodiment of the present disclosure. FIG. 4 is an exploded perspective view illustrating an internal space of the antenna apparatus illustrated in FIG. 2. FIG. 5 is a cross-sectional view taken along line A-A in FIG. 3A and a partially enlarged view thereof.

As referenced in FIG. 2, an antenna apparatus 1 according to the embodiment of the present disclosure includes a front heat dissipation housing 100 that forms a front appearance of the antenna apparatus 1 and a rear heat dissipation housing 200 that forms a rear appearance of the antenna apparatus 1.

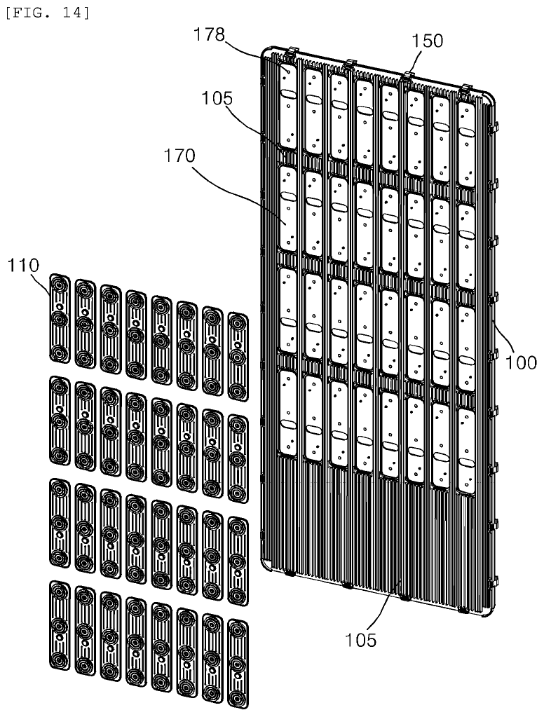

In this case, the front heat dissipation housing 100 includes antenna arrangement parts (refer to reference numeral “170” in FIG. 14, which is described later) in which one or more radiation elements 116 and 117 are disposed on a front surface thereof and a heat dissipation part 105 that is exposed to outside air and that transfers heat that is generated from the rear thereof to the front thereof.

In particular, the one or more antenna arrangement parts 170 are integrally formed on a front surface of the front heat dissipation housing 100 and disposed to be spaced apart from each other in a horizontal (H) direction and a vertical (V) direction. The heat dissipation part 105 may be formed in the entire area of the front surface of the front heat dissipation housing 100 so that the heat dissipation part is filled between the antenna arrangement parts 170 that are adjacent to each other.

Referring to FIGS. 2 to 5, the front heat dissipation housing 100 is made of a metal material having excellent heat conduction so that the front heat dissipation housing can directly discharge, to the front thereof, heat that is generated between the front heat dissipation housing and the rear heat dissipation housing 200 that is described later. As described above, the front surface of the front heat dissipation housing 100 may be basically divided into the antenna arrangement parts 170 and the heat dissipation parts 105 in terms of its appearance.

In this case, the remaining area portion of the front surface of the front heat dissipation housing except the antenna arrangement part 170 basically performs a function as the heat dissipation part 105. The heat dissipation part 105 has a form of a plurality of heat dissipation pins, and is integrally formed with the front heat dissipation housing 100 in a predetermined pattern shape. Heat that is generated in an internal space between the front heat dissipation housing 100 and the rear heat dissipation housing 200 can be rapidly discharged forward through the heat dissipation part 105 that is provided in the form of a plurality of a plurality of heat dissipation pins.

That is, an embodiment of the antenna apparatus 1 according to the present disclosure proposes a heat dissipation structure having a new concept, in which heat is discharged in all the directions of the antenna apparatus 1 by improving a structure in which the discharge of heat toward the front of the antenna apparatus 1 was limited, compared to a conventional technology including a radome.

More specifically, in the embodiment of the antenna apparatus 1 according to the present disclosure, an area that is occupied by the existing radome can be changed into a heat discharge area by introducing the front heat dissipation housing 100.

In the front heat dissipation housing 100, the entire area of the heat dissipation parts 105 except an area that is occupied at least by antenna modules 110 that are described later is changed into an available area capable of heat discharge. Furthermore, an available area capable of discharging more heat can be secured by providing a director 117 for radiation as a metal material capable of heat conduction, among the components of the antenna module 110.

As referenced in FIG. 3A, the front heat dissipation housing 100 may have a roughly rectangular plate body as a shape in which a front end of a rectangular parallelepiped enclosure of the rear heat dissipation housing 200 that is described later is covered.

The antenna arrangement parts 170 to which the plurality of antenna modules 110 that are described later are coupled may be flatly formed on the front surface of the front heat dissipation housing 100.

The plurality of antennas arrangement parts 170 are formed to be matched with appearances of the plurality of antenna modules 110, and are each provided as a rectangular plate body in which each antenna module 110 is lengthily formed in the vertical direction. The antenna modules 110 are disposed to be spaced apart from each other at predetermined intervals in a matrix form in the H direction and the V direction. The plurality of antennas arrangement parts 170 may be disposed on the front surface of the front heat dissipation housing 100 in the same shape as that of the plurality of antenna modules.

In this case, the plurality of antennas arrangement parts 170 may not be formed on the lower side of the rear heat dissipation housing 200 that is described later within an internal space thereof so that heat that is generated from a plurality of PSU elements 417 of a PSU unit 400 that is described later can be easily directly discharged forward through the heat dissipation parts 105.

The heat dissipation part 105 may be formed to fill portions corresponding to the remaining areas that are not occupied by the plurality of antennas arrangement parts 170 in the front surface of the front heat dissipation housing 100, in the form of a plurality of heat dissipation pins. In this case, the heat dissipation part 105 may have a shape that is enough to increase the heat dissipation area through the front heat dissipation housing 100, unlike in a case in which a shape of a plurality of rear heat dissipation pins 201 that are integrally formed in the rear heat dissipation housing 200, which are described later, are designed by considering the dispersion or rapid discharge of an ascending atmospheric current of rear heat that is discharged. That is, the heat dissipation part 105 does not need to essentially have a shape for the dispersion or rapid discharge of an ascending atmospheric current of front heat that is discharged (however, such a shape can increase heat dissipation performance), and may have any shape as long as a surface area of the front heat dissipation housing 100 is increased.

Meanwhile, the rear heat dissipation housing 200 forms the entire rear appearance of the antenna apparatus 1 by being coupled with the front heat dissipation housing 100. A main board 310 on which a plurality of filters 350 that filter an RF signal and a plurality of RF elements (reference numeral not indicated) related thereto, etc. are mounted is provided in an internal space 200S of the rear heat dissipation housing 200.

The rear heat dissipation housing 200 is made of a metal material having excellent heat conduction so that heat discharge according to heat conduction is generally advantageous, but is formed in a rectangular parallelepiped enclosure shape having a small thickness approximately in forward and backward directions thereof. The rear heat dissipation housing has a front surface formed to be opened, and thus the internal space 200S in which the main board 310 on which the plurality of RF filters 350, various RF elements, and field programmable gate arrays (FPGAs) 317a, etc. are mounted is installed may be formed within the rear heat dissipation housing.

Referring to FIG. 3B, a plurality of rear heat dissipation pins 201 are formed integrally with a rear surface of the rear heat dissipation housing 200 so that the plurality of rear heat dissipation pins have a predetermined pattern form. Heat that is generated from the rear part side on the basis of the main board 310 in the internal space 200S of the rear heat dissipation housing 200 may be directly discharged backward through the plurality of rear heat dissipation pins 201.

The plurality of rear heat dissipation pins 201 are each upward inclined and disposed toward the left end and right ends of a central portion in the left and right width thereof (refer to reference numeral 201a and 201b in FIG. 3B). The rear heat dissipation pin may be designed so that heat that is discharged to the rear of the rear heat dissipation housing 200 forms an ascending atmospheric current in which the heat is dispersed in the horizontal direction of the rear heat dissipation housing 200 and is thus more rapidly dispersed. However, the shape of the heat dissipation pin 201 is not limited thereto.

For example, although not illustrated in the drawings, if a blower fan module (not illustrated) is provided on the rear side of the rear heat dissipation housing 200, it may be preferred that the rear heat dissipation pins are formed in parallel from the blower fan module that is disposed at the center of the rear heat dissipation pins to the left end and right end thereof so that heat that is discharged by the blower fan module can be more rapidly discharged.

Furthermore, although not illustrated, bracket mounting parts 205 with which clamping devices (not illustrated) for coupling the antenna apparatus 1 with a support pole (not illustrated) are coupled may be integrally formed in some of the plurality of rear heat dissipation pins 201. In this case, the clamping device may be a component for adjusting the directivity of the antenna apparatus 1 according to the embodiment of the present disclosure by rotating the antenna apparatus 1 installed at the front end of the clamping device in the horizontal direction thereof or tilting and rotating the antenna apparatus 1 in the vertical direction.

Meanwhile, heat that is generated from the surroundings of the plurality of filters 350, as a space between a rear surface of the front heat dissipation housing 100 and the rear heat dissipation housing 200, is transferred to the front of the front heat dissipation housing 100 through a contact with the rear surface of the front heat dissipation housing 100 by directly using the front heat dissipation housing 100 as a heat transfer medium or using the filters 350 as a heat transfer medium. Furthermore, some of heat that is generated within the plurality of filters 350 may be directly discharged backward through the rear heat dissipation housing 200, which is described more specifically later.

Shield pads 330 that are described later are provided on a front surface of the main board 310, which is stacked and disposed in the internal space 200S of the rear heat dissipation housing 200, in a clamshell form so that the shield pad performs a function for blocking external electromagnetic waves from the plurality of RF filters 350, etc. and an interference function, and may be mounted and arranged at a preset location. This is described more specifically later.

In the antenna apparatus 1 according to an embodiment of the present disclosure, a total of eight RF filters 350 are adjacently arranged in the horizontal direction. An example in which a total of four columns of such RF filters 350 have been disposed in the vertical direction is adopted, but the present disclosure is not essentially limited thereto. It may be said to be natural that locations where the plurality of RF filters are arranged and the number of RF filters 350 may be variously designed and changed depending on the required capacity of a transmission channel.

Although not illustrated in the drawings, a plurality of cavities may be provided in each of the plurality of RF filters 350. The RF filter may be adopted and disposed as a cavity filter that filters the frequency band of an input signal versus an output signal by adjusting a frequency using the resonator of each cavity. However, the RF filter 350 is not essentially limited to the cavity filter and a ceramic waveguide filter is not excluded.

In a slimness implementation design of the entire product, it is advantageous that the RF filter 350 has a small thickness in the forward and backward directions. In view of the slimness design of such a product, to adopt a ceramic waveguide filter for which a miniaturization design is advantageous, compared to the cavity filter a downsize design for which is limited in thickness in the forward and backward directions, as the RF filter 350, may be considered. However, in order to satisfy high output performance of a base station antenna that is required for a 5G frequency environment, an antenna heat dissipation problem that is involved in the high output performance needs to be essentially solved. In order to effectively discharge heat that is generated within the antenna, the adoption of the cavity filter may be preferred in that heat that is generated from the filter 350 can be transferred to the front of the front heat dissipation housing 100 by using the RF filter 350 as a heat transfer medium.

Heat that is generated from the RF filter 350 may be transferred to the front of the front heat dissipation housing 100 through a contact with the rear surface of the front heat dissipation housing 100. A thermal pad 109 may be interposed between the filter 350 and the rear surface of the front heat dissipation housing 100. The thermal pad 109 performs a function for smoothly transferring heat that is generated from the filter 350 through a surface contact with the front heat dissipation housing 100 and also performs a function for solving a tolerance upon assembly between the filter 350 and the front heat dissipation housing 100.

Meanwhile, as referenced in FIG. 4, an inside that forms the internal space 200S of the rear heat dissipation housing 200 may be formed in a shape in which shapes of the main board 310 and a rear surface portion of a sub-board 320 that is described later are matched. That is, heat dissipation performance may be improved by increasing a heat contact area between the main board 310 and the rear surface portion of the sub-board 320.

Handle parts 160 which may be held by a worker on the spot so that the antenna apparatus 1 according to the embodiment of the present disclosure can be carried or can be easily mounted on the support pole (not illustrated) on the spot may be further installed on both left and right sides of the rear heat dissipation housing 200.

Furthermore, various outside mounting members 500 for a connection of a cable with a base station device that is not illustrated and the tuning of an internal part may be assembled with the rear heat dissipation housing 200 at the bottom of the rear heat dissipation housing on the outside thereof so that the outside mounting members penetrate the rear heat dissipation housing.

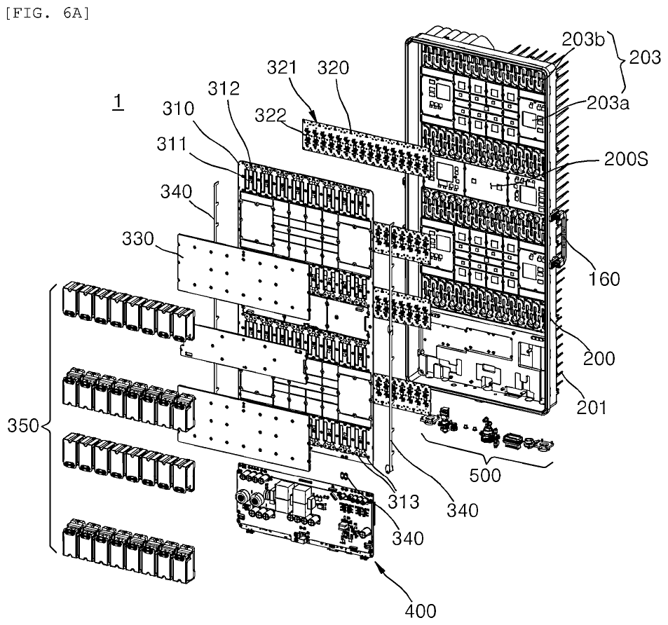

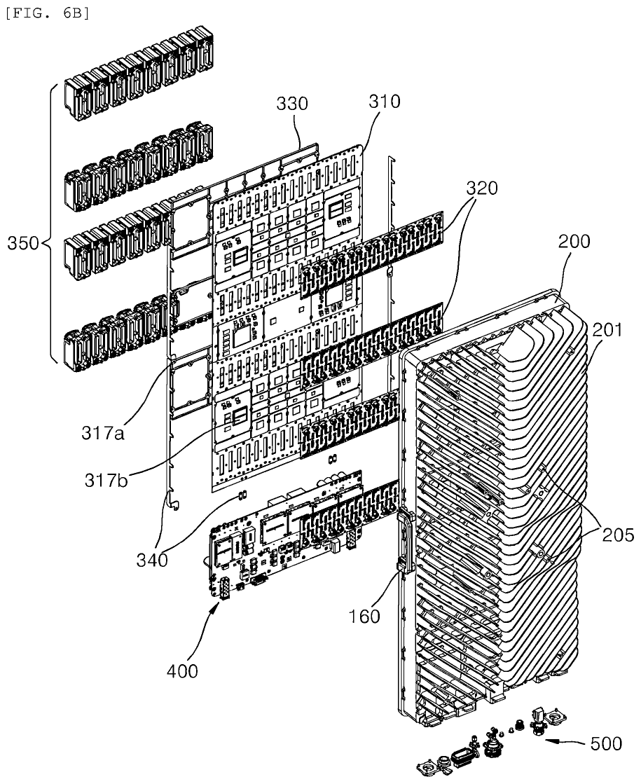

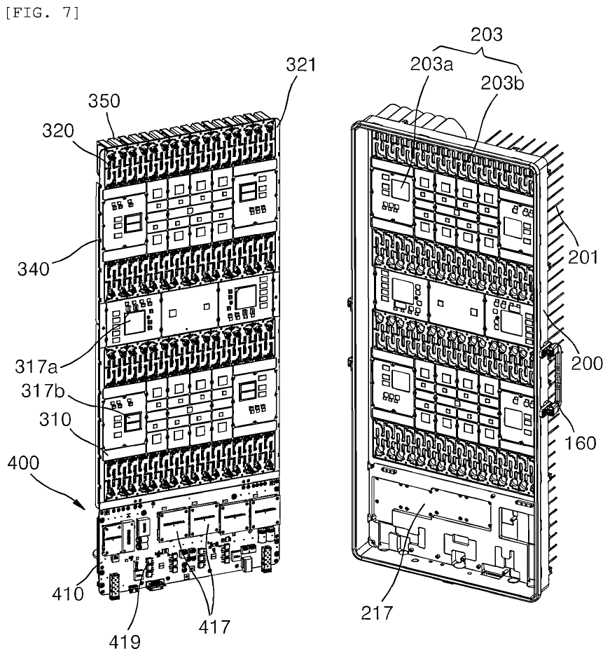

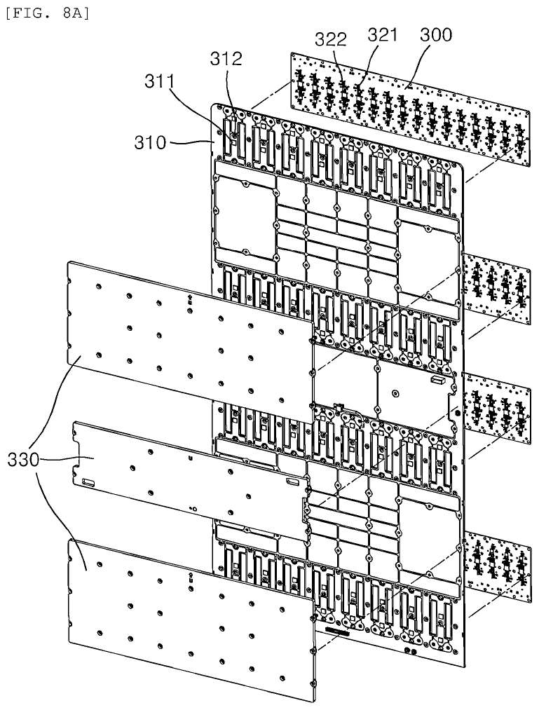

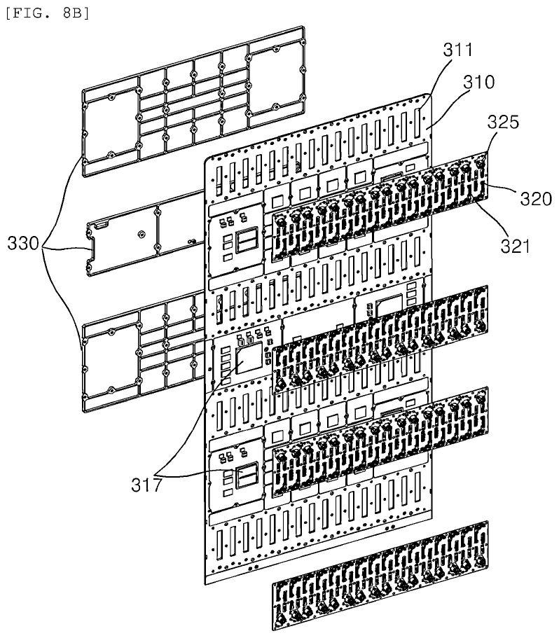

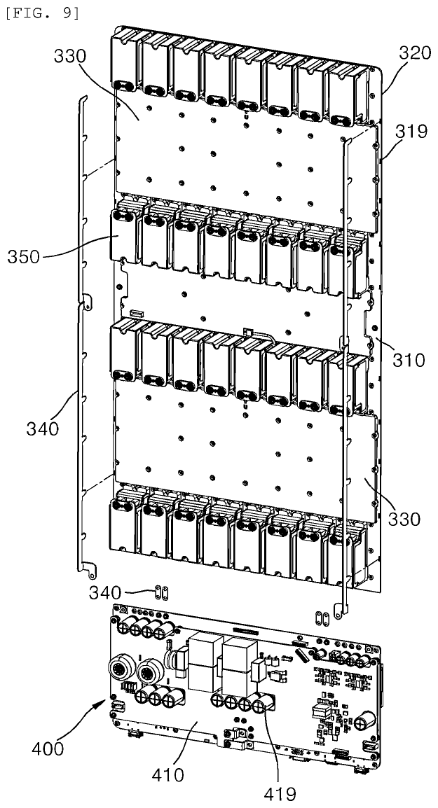

FIGS. 6A and 6B are front-side and rear-side exploded perspective views illustrating the main board and the filters that are stacked in the internal space of the rear heat dissipation housing, among the components of FIG. 2. FIG. 7 is an exploded perspective view illustrating a direct rear heat dissipation structure through the rear heat dissipation housing, among the components of FIG. 2. FIGS. 8A and 8B are front-side and rear-side exploded perspective views illustrating a form in which the sub-board and the shield panel, among the components of FIG. 2, have been installed in the main board. FIG. 9 is an exploded perspective view for describing a form in which the PSU unit, among the components of FIG. 2, is electrically connected to the main board.

The antenna apparatus 1 according to the embodiment of the present disclosure may include an antenna stack assembly 300 that is stacked and disposed in the internal space 200S of the rear heat dissipation housing 200, as referenced in FIGS. 6A and 6B.

As referenced in FIGS. 6A and 6B, the antenna stack assembly 300 may include the plurality of filters 350 as RF filters that are stacked on a front surface thereof on the basis of the main board 310 and the sub-board 320 that is stacked on a rear surface thereof on the basis of the main board 310.

Although not illustrated, the main board 310 may be stacked and provided in the form of a plurality of layers. Feeding circuits for feeding to the plurality of filters 350 may be patternized and printed within the main board or a surface thereof. In particular, an LNA element 312, among a plurality of feeding parts, may be mounted on the front surface of the main board 310. A plurality of feeding connectors 360 for feeding connections with the plurality of filters 350 may be inserted and mounted on the front surface of the main board.

Meanwhile, as in the main board 310, feeding circuits 321 for feeding to the plurality of filters 350 may be patternized and printed on a front surface of the sub-board 320 in pairs, each one as a transmission path and a reception path. PA elements 322, among the plurality of feeding parts, may be mounted on the front surface of the sub-board.

In this case, a plurality of through parts 312 may be processed and formed in the main board 310 so that the feeding circuits 321 and the PA elements 322 on the front surface of the sub-board 320, among the components of the sub-board 320 stacked on the rear surface of the main board, are exposed toward the rear side of the plurality of filters 350.

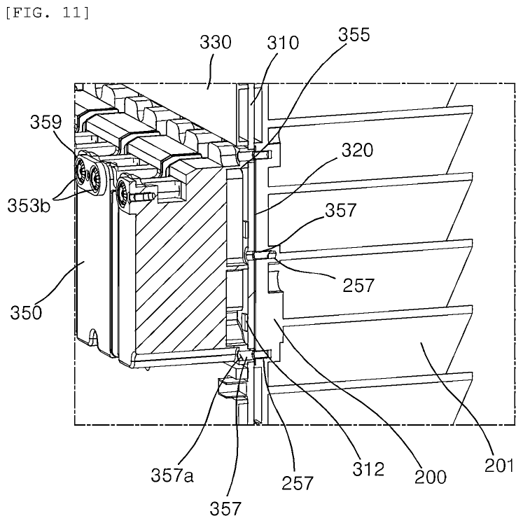

Furthermore, clamshells (reference numeral not indicated) are integrally formed on the rear end side of the plurality of filters 350 as described above. A predetermined air layer may be formed between the rear end side of the plurality of filters 350, the main board 310, and the sub-board 320. Heat that is generated from the LNA elements 312 and the PA elements 322, that is, representative heat generation elements, may be discharged toward the rear heat dissipation housing 200 through heat discharge via holes (refer to reference numeral “357a” in FIG. 11) that are formed in the main board 310.

As referenced in FIG. 7, a plurality of FPGA elements 317a and RFIC elements 317b, that is, representative heat generation elements, may be mounted and disposed on a rear surface of the main board 310. The plurality of FPGA elements 317a and the plurality of RFIC elements 317b are semiconductor elements that discharge a large amount of heat upon driving, and are each adopted as having a structure in which the element discharges heat backward through the rear heat dissipation housing 200 through a direct surface thermal-contact with the inside of the internal space 200S of the rear heat dissipation housing 200.

More specifically, as referenced in FIG. 7, thermal contact accommodation surfaces 203a with which surfaces of the plurality of FPGAs 317a and RFIC elements 317b are brought into direct thermal-contact are formed on the inside of the rear heat dissipation housing 200 so that the thermal contact accommodation surfaces protrude therefrom. Furthermore, thermal contact grooves 203b in which a plurality of protrusion parts that are embossed, patternized, and printed or mounted are accommodated may be processed and formed on the rear surface side of the sub-board 320 in an intaglio form in which the thermal contact grooves are depressed backward. Accordingly, there is an advantage in that heat dissipation performance is greatly improved because all of the rear surfaces of the main board 310 and the sub-boards 320 are brought into surface thermal-contact with the inside of the rear heat dissipation housing 200.

Meanwhile, the shield pads 330 may be stacked and coupled with the remaining portions except portions that are occupied by the plurality of filters 350, in the front surface of the main board 310, in the clamshell form, as referenced in FIGS. 8A and 8B. The shield pad 330 is a shield member that is disposed between the main board 310 and the front heat dissipation housing 100 and that enables stabler signal performance to be secured by blocking the influence of a signal due to electronic parts in the remaining portions except an electrical signal line through the plurality of filters 350 or external electromagnetic waves.

As referenced in FIGS. 6A, 6B, and 7, the antenna apparatus 1 according to the embodiment of the present disclosure may further include the PSU unit 400 for supplying power to the plurality of filters 350 and the antenna module 110.

As referenced in FIGS. 6A, 6B, and 7, the PSU unit 400 may be stacked and disposed in the internal space 200S of the rear heat dissipation housing 200 at the same height as the main board 310 under the main board 310.

The PSU unit 400 may include a PSU board 410, and a plurality of electric elements 419 including a plurality of PSU elements 417 disposed in any one of a front surface or rear surface of the PSU board 410.

The PSU unit 400 may be provided to distribute and supply power to the main board 310 through the medium of a plurality of bus bars 340. More specifically, as referenced in FIGS. 6A, 6B, and 9, the plurality of bus bars 340 are disposed to connect the PSU board 410 and the left end and right end of the main board 310. In particular, the plurality of bus bars 340 may be connected to the main board 310 by an operation of being inserted into connection holes 319 that have already been formed.

In particular, the PSU elements 417 and electronic elements 419 of the PSU unit 400 discharge a large amount of heat upon driving. As referenced in FIG. 7, a thermal contact accommodation part 217 may be formed in a portion that belongs to the internal space 200S of the rear heat dissipation housing 200 and that is occupied by the PSU board 410 in a way to correspond to a shape of the PSU elements 417 and the electronic elements 419 so that the thermal contact accommodation part is depressed backward. Accordingly, heat that is generated from the PSU elements 417 and electronic elements 419 of the PSU unit 400 can be discharged backward by using the rear heat dissipation housing 200 as a heat transfer medium.

However, heat that is generated from the PSU unit 400 does not need to be essentially discharged backward through the rear heat dissipation housing 200. Although not illustrated, it may be said to be natural that the heat is discharged forward toward the front heat dissipation housing 100 through the medium of a vapor chamber or heat pipe structure that is separately provided as a heat transfer medium. This is because the antenna apparatus 1 according to an embodiment of the present disclosure has a structure in which front heat dissipation through the front heat dissipation housing 100 is advantageous unlike in the case in which a conventional radome is provided.

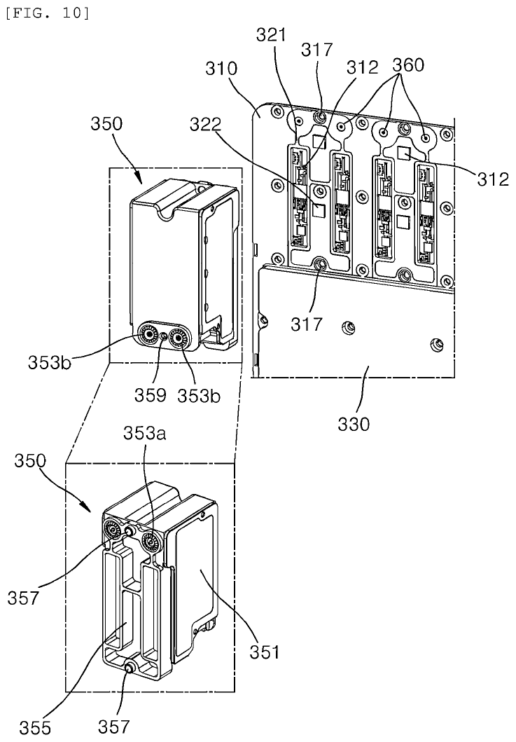

FIG. 10 is an exploded perspective view for describing a form in which the filters have been coupled with the main board, among the components of FIG. 2. FIG. 11 is a partial cutaway perspective view for describing a form in which heat that is generated from the filter is discharged through the medium of the rear heat dissipation housing, among the components of FIG. 2.

As described above in relation to the front surface and rear surface of the main board 310, when the shield pad 330 and the sub-board 320 are stacked and disposed, the plurality of filters 350 are mounted and disposed on the front surface of the main board 310 as the RF filters, as referenced in FIGS. 10 and 11.

In this case, the plurality of filters 350 may each be a cavity filter in which a clamshell for shielding electromagnetic waves from the outside has been integrally provided at the rear end thereof. In this case, it is to be noted that the clamshell is a component that is different from the shield pad 330 that is provided in a clamshell form so that the shield pad covers the front surface of the main board 310 as described above.

At least one filter assembly protrusion 357 that is inserted into a filter assembly hole 317 formed in the main board 310 and that is assembled with the main board is formed in a portion in which the clamshell has been formed, among the plurality of filters 350. The filter assembly protrusion 357 may be formed in the form of a tube the inside of which is empty.

Accordingly, heat that is generated from the LNA elements 312 and the PA elements 322 and that is collected, in an air layer between the rear ends of the plurality of filters 350 and the main board 310, can be easily discharged toward the rear heat dissipation housing 200 through the filter assembly protrusion 357 having the tube form and the heat discharge via holes 357a formed in the main board 310.

Meanwhile, as referenced in FIG. 10, a pair of main board-side coaxial connectors 353a that are electrically connected to the feeding connector 360 mounted on the main board 310 is provided at the rear end of each of the plurality of filters 350. A pair of antenna-side coaxial connectors 353b that is electrically connected to the antenna module 110 disposed on the front surface of the front heat dissipation housing 100 may be provided at the front end of each of the plurality of filters 350.

Furthermore, the thermal pad 109 that mediates the transfer of heat to the rear surface of the front heat dissipation housing 100 is disposed at the front end of each of the plurality of filters 350 so that heat that is generated from each of the plurality of filters 350 can be more rapidly discharged forward by using the front heat dissipation housing 100 as a heat transfer medium.

A screw fastening hole 359 for screw coupling using a fixing screw 351 with respect to the front heat dissipation housing 100 is formed at the front end of each of the plurality of filters 350. The front heat dissipation housing 100 may be stacked and coupled with a front surface of the plurality of filters 350 by an operation of the fixing screw 351 being fastened to the screw fastening hole 359 through a screw through hole 119 formed in the front heat dissipation housing 100.

According to the above construction, it could be seen that an effect in that a temperature of heat that was generated from the filter 350 dropped by about 14 to 16° C., compared to a conventional technology, because the heat was brought into direct contact with the rear surface of the front heat dissipation housing 100 or the director 117 for radiation, among the components of the antenna module 110. It is understood that such a drop results from an influence according to improved heat transfer performance through direct heat transfer (heat conduction) for the rear surface of the front heat dissipation housing 100 and the director 117 for radiation, which are made of a material that is suitable for discharging heat of the filters 350, in addition to an influence attributable to the removal of the conventional radome, that is, an obstacle to heat dissipation.

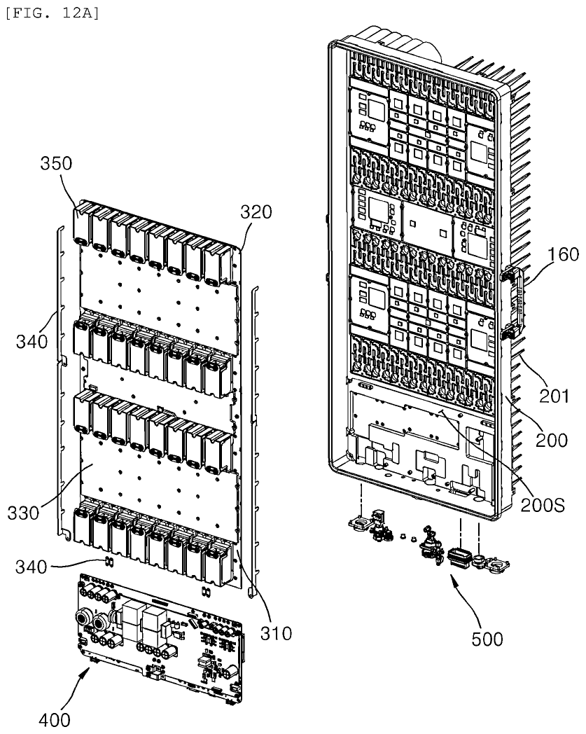

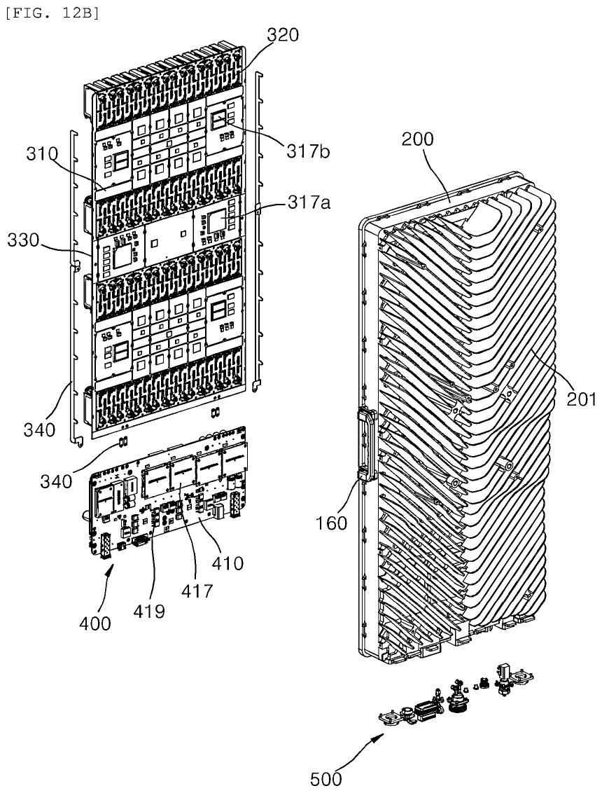

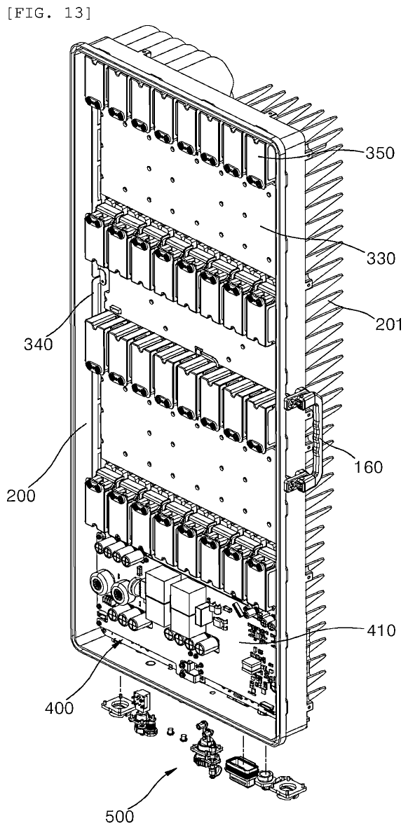

FIGS. 12A and 12B are front-side and rear-side exploded perspective views of a process of assembling internal components, among the components of FIG. 2, with the rear heat dissipation housing. FIG. 13 is an exploded perspective view for describing a process of assembling outside members, among the components of FIG. 2, with the rear heat dissipation housing.

As referenced in FIGS. 2 to 11, when the assembly of components with the main board 310 and the assembly of the stack assembly 300 with the rear heat dissipation housing 200 are completed, the assembly of an outside member 500 is completed by moving the outside member from the lower end of the rear heat dissipation housing 200 as referenced in FIGS. 12A to 13.

In this case, the internal space 200S of the rear heat dissipation housing 200 is fully shielded and sealed by the assembly of the front heat dissipation housing 100 and the antenna module 110, which is described later, and a protection member, such as a separate radome, is not required.

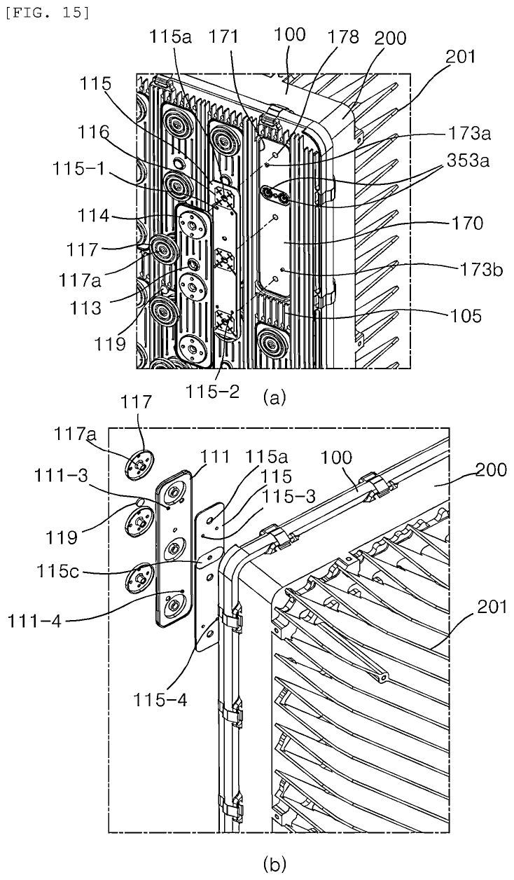

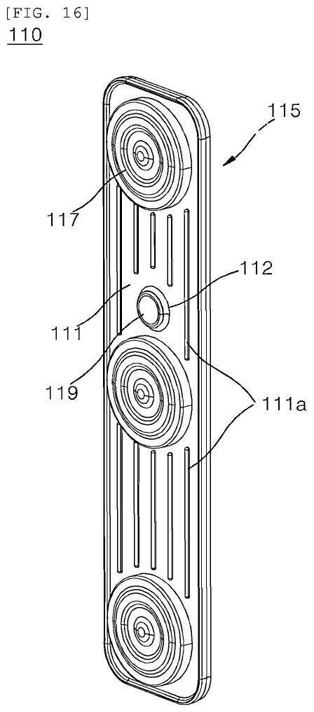

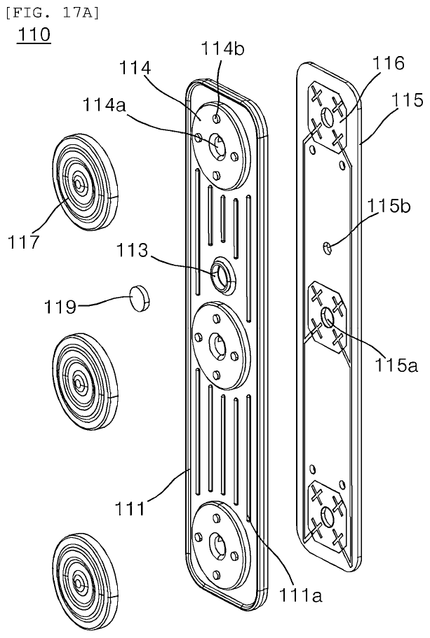

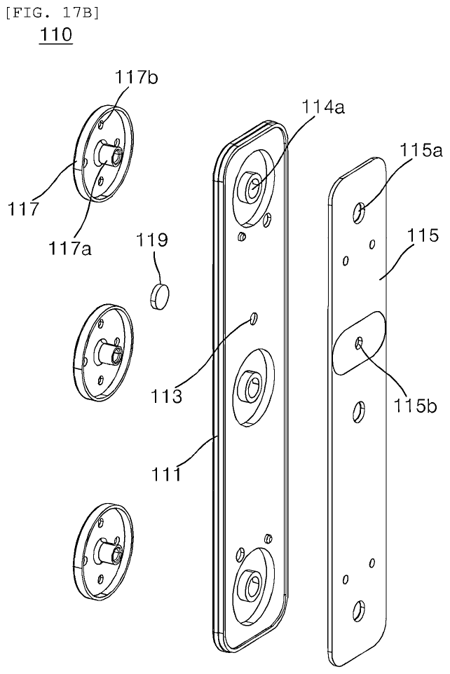

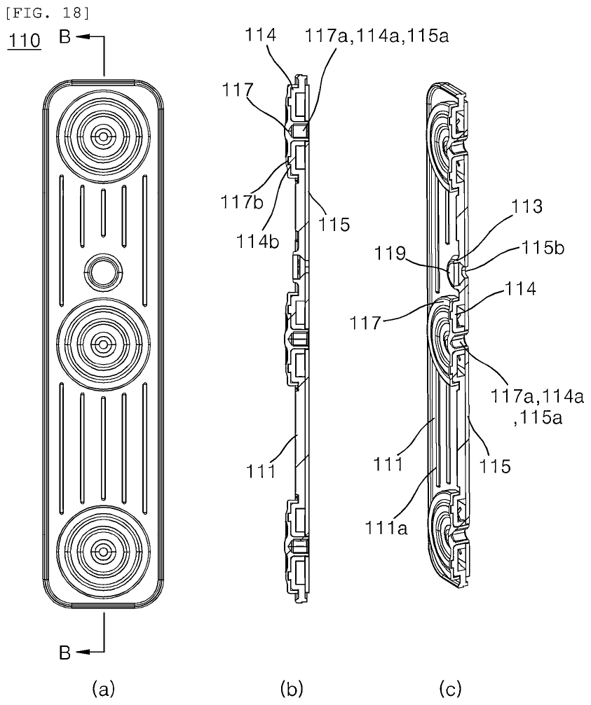

FIG. 14 is a front-side exploded perspective view for describing a form in which the antenna module, among the components of FIG. 2, has been installed in the front heat dissipation housing. FIG. 15 is a front-side and rear-side exploded perspective view of a form in which the antenna module, among the components of FIG. 14, has been installed on the front surface of the front heat dissipation housing. FIG. 16 is a perspective view illustrating the antenna module, among the components of FIG. 14. FIGS. 17A and 17B are front surface-side exploded perspective view and rear surface-side exploded perspective view of FIG. 14. FIG. 18 is a front view of the antenna module, among the components of FIG. 14, and is a cross-sectional view taken along line B-B and a cutaway perspective view thereof.

For an implementation of beamforming, as referenced in FIGS. 14 to 18, the plurality of radiation elements are necessary for an array antenna. The plurality of radiation elements may increase the concentration of electromagnetic waves in a designated direction by generating a narrow directional beam.

Recently, a dipole type dipole antenna or a patch type patch antenna is used as a plurality of radiation elements with the highest frequency. The plurality of radiation elements are designed and disposed to be spaced apart from each other so that signal interference therebetween is minimized. Conventionally, a radome that protects the plurality of radiation elements against the outside was commonly used as an essential component so that such an array design of the plurality of radiation elements is not changed due to an external environment factor. Accordingly, an area part that is covered by the radome is very limited in discharging system heat that is generated due to an operation of the antenna apparatus 1 to the outside because the plurality of radiation elements and the antenna board in which the plurality of radiation elements are installed are not exposed to outside air.

A radiation element (reference numerals not indicated) of the antenna apparatus 1 according to the embodiment of the present disclosure may be implemented in the form of the director 117 for radiation, which is formed on a front surface of an antenna patch circuit part 116 that is printed and formed on a printed circuit board 115 for radiation elements that is disposed in the antenna arrangement part 170, as a conductive metal material, and electrically connected thereto. The antenna patch circuit part 116 is printed and formed on the printed circuit board 115 for radiation elements, and is provided as a dual polarization patch element that generates dual polarization of any one of ±45 polarizations or vertical/horizontal polarizations that are orthogonal to each other. A feeding line (reference numeral not indicated) that supplies a feeding signal to the antenna patch circuit part 116 is patternized and formed on the printed circuit board 115 for radiation elements so that the antenna patch circuit parts 116 are connected.

In the conventional antenna apparatus, the feeding line needs to be formed under the printed circuit board on which the antenna patch circuit part is mounted. For this reason, there are problems in that a feeding structure is complicated because a plurality of through holes are provided, etc., and the feeding structure acts as an obstacle to a direct surface thermal-contact between the filters 350 and the printed circuit board 115 for radiation elements because the feeding structure occupies a lower space of the printed circuit board 115 for radiation elements. In contrast, the feeding line according to an embodiment of the present disclosure has advantages in that the feeding structure is very simplified and a coupling space in which the filters 350 and the printed circuit board 115 for radiation elements are brought into direct surface thermal-contact with each other can be secured because the feeding line is patternized, printed, and formed on the same front surface as that of the printed circuit board 115 for radiation elements on which the antenna patch circuit part 116 s patternized and printed.

Meanwhile, the director 117 for radiation is made of a heat conductive or conductive metal material and electrically connected to the antenna patch circuit part 116. The director 117 for radiation may perform a function for inducing a radiation beam in all directions and also transferring heat that is generated from the rear of the printed circuit board 115 for radiation elements to the front thereof through heat conduction. The director 117 for radiation may be made of a conductive metal material through which electromagnetic waves flow well, and is installed to be spaced apart from the front surface of the antenna patch circuit part 116.

In this case, the height of a heat dissipation part 105 (front heat dissipation pin) of the front heat dissipation housing 100 may be set by the length of the director 117 for radiation that is coupled with an antenna module cover 111 to be described later. By variably designing the height of the director 117 for radiation, the amount of heat dissipated can be adjusted by changing the corresponding height of the heat dissipation part 105 (heat dissipation pin).

In an embodiment of the present disclosure, the radiation element using the antenna patch circuit part 116 and the director 117 for radiation has been described. If a dipole antenna is applied, however, the construction of the director for radiation may be omitted. The amount of heat dissipated can be increased by setting the height of the heat dissipation part 105 (heat dissipation pin) high as the height of the dipole antenna is relatively high.

Referring to FIGS. 14 to 18, a protrusion part 117a that is formed on a rear surface of the director 117 for radiation is electrically connected to the antenna patch circuit part 116 through a through hole 114a of the antenna module cover 111.

An overall size, form, and installation location, etc. of the director 117 for radiation may be properly designed experimentally by measuring a characteristic of a radiation beam that is radiated by a corresponding antenna patch circuit part 116 or through the simulations of the corresponding characteristic.

The director 117 for radiation plays a role to induce a radiation beam that is generated by the antenna patch circuit part 116 in all directions, and also makes characteristics of a side lobe excellent while further reducing an overall beam width of an antenna.

Furthermore, the director for radiation compensates for a loss attributable to the patch type antenna, and is made of a conductive metal material and may also perform a heat dissipation function. It is preferred that the director 117 for radiation is formed in a shape that is suitable for inducing a radiation beam in all directions, for example, a circular shape having non-directivity, but the present disclosure is not limited thereto.

Meanwhile, the one or more radiation elements may be implemented in the form of one antenna module 110.

For example, the antenna module 110 may be defined as a concept that includes the antenna patch circuit part 116 that is printed and formed on the printed circuit board 115 for radiation elements disposed in the antenna arrangement part 170, the antenna module cover 111 that is disposed to cover the front surface of the antenna patch circuit part 116, and the director 117 for radiation that is disposed on a front surface of the antenna module cover 111, made of a conductive metal material, and electrically connected to the antenna patch circuit part 116.

FIGS. 14 to 18 illustrate an example in which three antenna patch circuit parts 116 and directors 117 for radiation form one unit antenna module 110. The number of antenna patch circuit parts 116 and directors 117 for radiation may vary depending on an optimal design of the antenna module for increasing a gain.

The antenna module 110 may further include the antenna module cover 111 that seals at least one side of the printed circuit board 115 for radiation elements, among the components of the antenna module 110, as described above. The antenna module cover 111 may be molded by using a plastic resin material having relatively small weight.

A cover through hole 113 and a board through hole 115b that are each penetrated in forward and backward directions thereof are formed in the antenna module cover 111 and the printed circuit board 115 for radiation elements, respectively. The antenna module 110 may be fixed to a front surface of the antenna arrangement part 170, by an operation of the fixing screw 351 sequentially penetrating the cover through hole 113 and the board through hole 115b from the outside of the front heat dissipation housing 100, penetrating the screw through hole 119 of the front heat dissipation housing 100, and being fastened to the screw fastening hole 359 that is formed at the front end of each of the plurality of filters 350.

In this case, as referenced in (a) of FIG. 15, an accommodation rib 178 in which at least an edge end of the antenna module cover 111 is accommodated is formed at an edge portion of the antenna arrangement part 170. It is preferred that the antenna module cover 111 is formed to the size in which the antenna module cover is forcedly fit into the accommodation rib 178 of the antenna arrangement part 170 and can be airtight or waterproof.

Meanwhile, as referenced in FIG. 15, location setting holes 115-1 to 115-4 that are each penetrated in forward and backward directions thereof are formed at four places of the printed circuit board 115 for radiation elements on the edge sides thereof, which form a quadrangle. Two location setting protrusions 173a and 173b that are pressed in two location setting holes 115-1 and 115-2 in a diagonal direction thereof, among the four location setting holes 115-1 to 115-4 formed in the printed circuit board 115 for radiation elements, are formed on the front surface of the antenna arrangement part 170. Two location setting protrusions 111-3 and 111-4 that are pressed in the remaining two location setting holes 115-3 and 115-4 that are not occupied by the two location setting protrusions 173a and 173b formed on the front surface of the antenna arrangement part 170, among the four location setting holes 115-1 to 115-4 formed in the printed circuit board 115 for radiation elements, may be formed on a rear surface of the antenna module cover 111.

Accordingly, as referenced in FIG. 15, when the antenna module 110 is installed in the antenna arrangement part 170, after the rear surface side of the antenna module cover 111 is fixed to the printed circuit board 115 for radiation elements (refer to (b) in FIG. 15) by an operation of the two location setting protrusions 111-3 and 111-4 pressing and inserting the two location setting protrusions 111-3 and 111-4, which are formed on the rear surface side of the antenna module cover 111, into the two location setting holes 115-3 and 115-4 by moving the printed circuit board 115 for radiation elements to the rear surface side of the antenna module cover 111, the antenna module cover 111 may be temporarily fixed to the printed circuit board 115 for radiation elements by an operation of pressing and inserting the two location setting protrusions 173a and 173b to the two location setting holes 115-1 and 115-2 of the printed circuit board 115 for radiation elements by moving the antenna module cover 111 with which the printed circuit board 115 for radiation elements has been coupled toward the antenna arrangement part 170 formed in a front surface of the front heat dissipation housing 100.

That is, the printed circuit board 115 for radiation elements can be stably disposed between the antenna module cover 111 and the antenna arrangement part 170 as the location setting protrusions 111-3, 111-4, 173a, and 173b are pressed and inserted into the location setting holes 115-1 to 115-4, respectively, on the rear surface of the antenna module cover 111 provided to cover a front surface of the printed circuit board and the front surface of the antenna arrangement part 170 of the front heat dissipation housing 100 provided so that the rear surface of the printed circuit board is closely attached thereto.

Meanwhile, as referenced in FIG. 15, the antenna patch circuit part 116 is printed and formed on the front surface of the printed circuit board 115 for radiation elements. A conductive contact pattern 115c is printed and formed on a rear surface of the printed circuit board 115 for radiation elements. Power can be supplied toward the antenna patch circuit part 116 by a contact between the antenna-side coaxial connector 353b that is provided at the front end of the filter 350 and the contact pattern 115c.

In this case, the antenna module cover 111 is injected and molded by using a plastic material. As referenced in FIG. 17A, a director fixing part 114 the shape of which is matched with the rear surface of the director 117 for radiation is provided on one side of the antenna module cover 111. Director fixing protrusion parts 114b which may be coupled with the director 117 for radiation may be formed in the director fixing part 114 so that the director fixing protrusion parts protrude forward.

Furthermore, as referenced in FIG. 17B, the director 117 for radiation may be pressed and fixed to at least one director fixing groove 117b that is depressed and formed at a location corresponding to the at least one director fixing protrusion parts 114b on the rear surface thereof.

Furthermore, a filter fixing hole 113 for a coupling with the filter 350 may be formed to penetrate the antenna module cover 111. After a filter fixing screw (not illustrated) penetrates the antenna module cover 111 through the filter fixing hole 113, when the filter fixing screw is fastened to the screw fastening hole 359 formed in the filter 350 through the through hole 115b formed in the printed circuit board 115 for radiation elements, the front heat dissipation housing 100 can be firmly stacked and coupled with the front surface of the filter 350. It is preferred that as referenced in FIG. 16, the filter fixing hole 113 is sealed through a hole shield cap 119.

In this case, the at least one board fixing hole 114a for screw fastening by a fixing screw 180 with the printed circuit board 115 for radiation elements may be formed in the antenna module cover 111. Furthermore, the at least one fixing boss 117a that is exposed to the rear surface of the antenna module cover 111 through the board fixing hole 114a may be formed in the rear surface of the director 117 for radiation. The printed circuit board 115 for radiation elements may be fixed to the rear surface of the antenna module cover 111, by an operation of the fixing screw 180 being fastened to the fixing boss 117a after penetrating the director fixing hole 178 that is formed to penetrate the antenna arrangement part 170 of the front heat dissipation housing 100 in forward and backward directions thereof.

Meanwhile, it is preferred that the fixing screw 180 is provided as a dishhead screw the rear end of which is matched and fastened to the front surface of the filter 350 that is disposed behind the fixing screw. This is for bringing a rear cross section of the fixing screw 180, which is provided as the dishhead screw, into surface thermal-contact with the front surface of the filter 350 with a maximum possible area. The fixing screw 180 and the director 117 for radiation are each made of a heat conductive material. Heat that is discharged to the internal space 200S between the front heat dissipation housing 100 including the filter 350, and the main board 310 and the PSU unit 400 may be discharged to the front side through heat conduction of the front heat dissipation housing 100 itself or a heat conduction method through the fixing screw 180 and the director 117 for radiation.

Furthermore, at least one reinforcement rib 111a is formed on one side of the antenna module cover 111, forms an appearance of the antenna module cover 111, and can reinforce the strength of the antenna module cover 111 made of the plastic material.

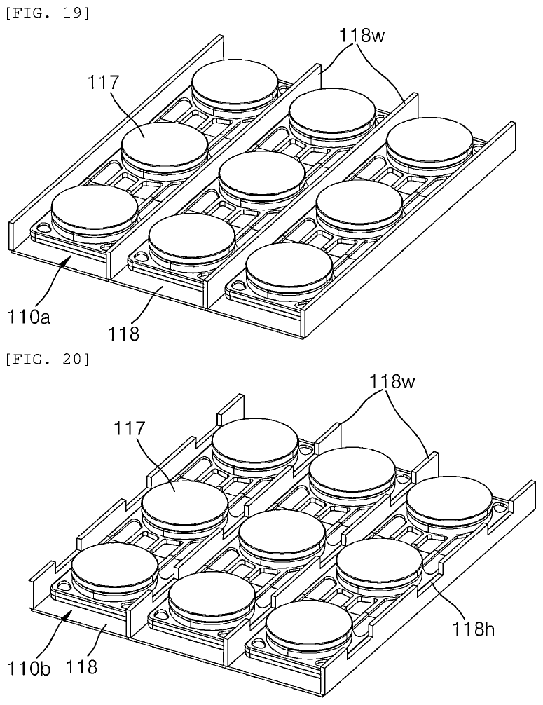

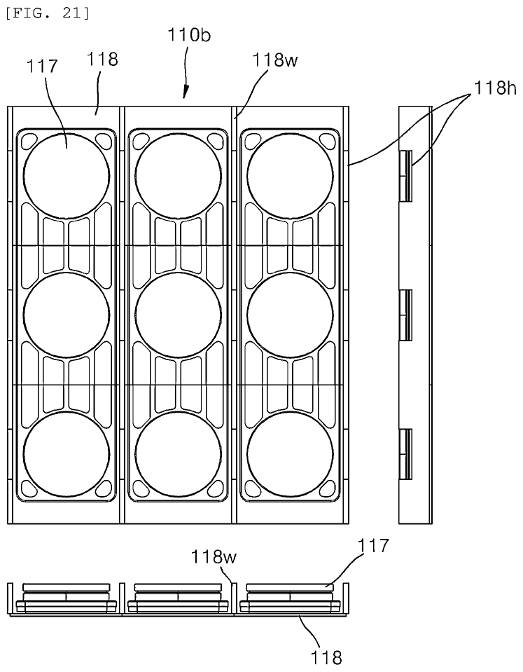

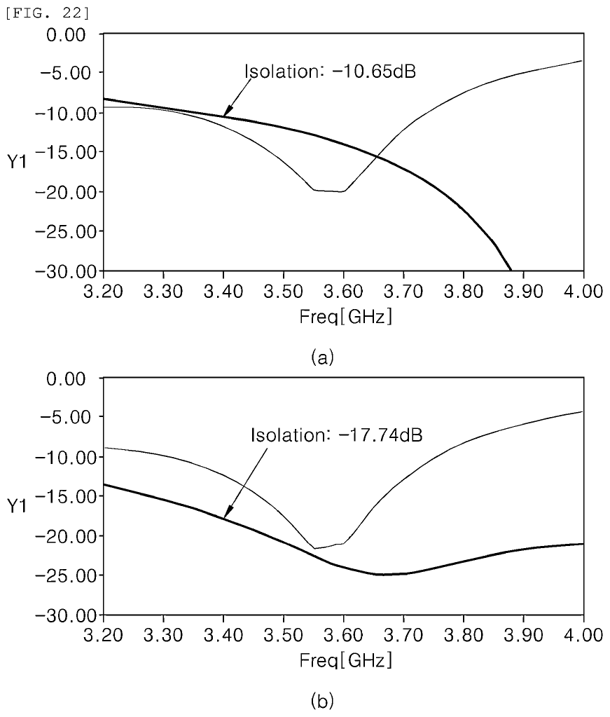

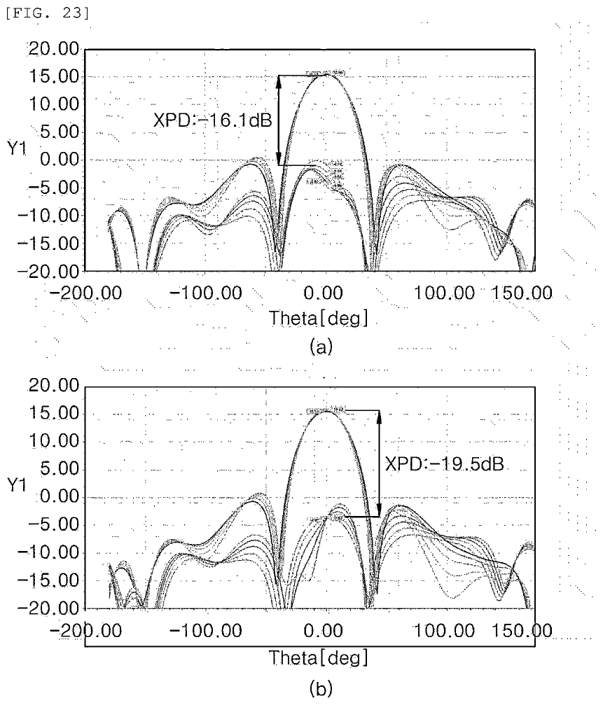

FIG. 19 is a perspective view illustrating another embodiment of the antenna module. FIG. 20 is a perspective view illustrating a modified example of FIG. 19. FIG. 21 illustrates three surface views (a front view, a side view, and a plane view) in FIG. 20. FIGS. 22 and 23 are graphs for comparing cross polarization discrimination (XPD) values and isolation values of the antenna modules in FIGS. 19 and 20.

As referenced in FIGS. 19 and 20, the antenna apparatus 1 according to the embodiment of the present disclosure may further include a module installation plate 118 provided so that the area of the antenna arrangement part 170 formed on the front surface of the front heat dissipation housing 100 is extended and the at least two antenna modules 110 are simultaneously installed in the antenna arrangement part 170 having the extended area.

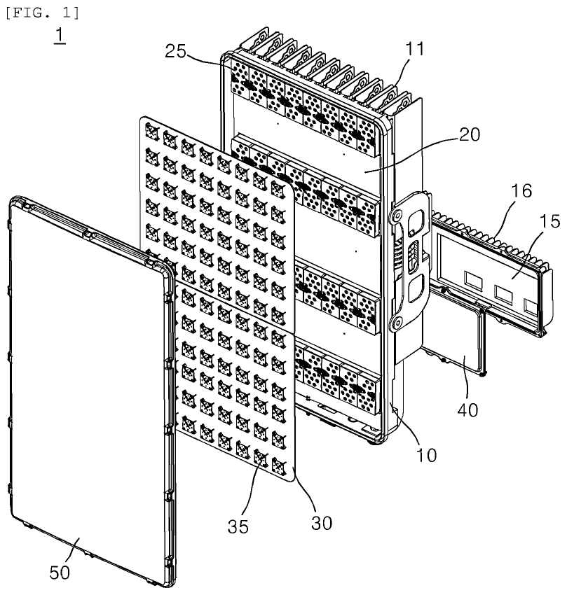

In this case, the module installation plate 118 may be understood as a component that means the front heat dissipation housing 100 itself that has already been described with reference to FIGS. 1 to 18, and may be defined as a medium that mediates the coupling of the remaining component having a module type with the front surface of the front heat dissipation housing 100 separately as one component of the antenna module 110. Accordingly, the module installation plate 118 that is described hereinafter may be understood by substituting the module installation plate with the front heat dissipation housing 100. Partition walls 118w and window grooves 118h formed in the module installation plate 118, which are described later, may also be understood as alternative components of the heat dissipation part (front heat dissipation pin) 105 of the front heat dissipation housing 100.

As referenced in FIGS. 19 and 20, at least two (three antenna modules have been illustrated in the drawings, but it is to be noted that the present disclosure is not limited thereto) antenna modules 110a and 110b may be installed in the module installation plate 118 in parallel.

Furthermore, the partition walls 118w that partition the antenna modules 110a and 110b may be formed in the module installation plate 118. It is preferred that the module installation plate 118 including the partition walls 118w is made of a metal material so that heat transferred by the front heat dissipation housing 100 is smoothly discharged. It is advantageous in terms of heat dissipation that the module installation plate is formed to have a protrusion height so that the module installation plate is formed to more protrude forward than the front end of the director 117 for radiation.

In this case, in the case of an embodiment in which the antenna module 110 is directly installed in the antenna arrangement part 170 that is provided on the front surface of the front heat dissipation housing 100 without the module installation plate 118, the partition wall 118w may be understood as being implemented as any one of the plurality of front heat dissipation pins (heat dissipation parts) 105.

However, in this case, the partition wall 118w may be defined as a component that partitions the antenna arrangement parts 170 that are disposed to be adjacent to each other in the H direction, and may also be defined as a component that partitions the two antenna modules 110 themselves that are disposed to be spaced apart from each other in the H direction.

In this case, some of the plurality of front heat dissipation pins 105 are provided in the form of the at least one partition wall 118w that partitions the two or more antenna arrangement parts 170 in the H direction.

In particular, the front end of the at least one partition wall 118w may be provided to protrude from the front surface of the front heat dissipation housing 100 or the module installation plate 118 identically with a front surface of a radiation element (in particular, the director 117 for radiation).

However, the front end of the partition wall 118w does not need to essentially protrude identically with the front surface of the director 117 for radiation, and may be provided to more forward protrude than the front surface of the director 117 for radiation.

However, it is advantageous in terms of heat dissipation as the amount of protrusion of the partition wall 118w is increased, but the XPD and isolation characteristics may be relatively degraded, as referenced in FIGS. 22 and 23.

Therefore, as referenced in FIG. 20, in an antenna module 110b according to the modified example, a plurality of window grooves 118h may be formed in a partition wall 118w in order to prevent the degradation of the XPD and isolation characteristics while maintaining a heat dissipation effect by the partition wall 118w.

It is preferred that the plurality of window grooves 118h are formed to be opened in the horizontal direction (i.e., in the H direction on the basis of the director 117 for radiation) at locations close (adjacent) to the left end or right end of the director 117 for radiation, among components of the antenna module 110 that is coupled between the partition walls 118w.

For example, as referenced in FIGS. 20 and 21, if the antenna module 110 in which three directors 117 for radiation have been arranged in the vertical direction is fixed to one module installation plate, three window grooves 118h may be formed in one partition wall 118w.

In particular, it is preferred that the incision depths of the plurality of window grooves 118h are differently designed by considering isolation performance measurement values with the radiation elements that are adjacent to the window groove in the H direction, in that there is a certain degree of a difference between the reductions of the XPD/isolation characteristics of a case in which the window groove 118h has not been formed in the partition wall 118w (refer to (a) in each of FIGS. 22 and 23) and a case in which the window grooves 118h have been formed in the partition wall 118w (refer to (b) in each of FIGS. 22 and 23), as referenced in FIGS. 22 and 23.

The antenna apparatus according to the embodiment of the present disclosure is limited to the example in which the module installation plate 118 is separately provided and the partition wall 118w is provided in the module installation plate 118. However, the partition wall 118w does not need to be essentially provided in the module installation plate 118 that is separately provided. A heat dissipation pin that is most adjacent to the antenna module 110, among the components of the heat dissipation part 105 provided in the form of a plurality of heat dissipation pins, may be provided as the partition wall 118w, and the plurality of window grooves 118h may be formed in any one itself of the plurality of front heat dissipation pins 105.

It may be seen that the XPD and isolation characteristics of the antenna module 110a (refer to FIG. 19) according to another embodiment and the antenna module 110b (refer to FIGS. 20 and 21) according to the modified example, which have been constructed as above, are improved as a graph change (a)→(b) depending on whether the plurality of window grooves 118h is provided, as referenced in FIGS. 22 and 23. In this case, (a) in each of FIGS. 22 and 23 is a graph relating to the antenna module 110a according to another embodiment, and (b) in each of FIGS. 22 and 23 is a graph relating to the antenna module 110b according to the modified example to which the window grooves 118h have been further added.

A form in which the antenna apparatus 1 constructed as above according to the embodiment of the present disclosure discharges heat is described in brief as follows.

Heat that is generated between the main board 310 and the front heat dissipation housing 100 on the basis of the main board 310 and heat that is generated from the filter 350 corresponding to a space therebetween may be discharged to the front of the front heat dissipation housing 100 through a direct surface thermal-contact with the rear surface of the front heat dissipation housing 100 or through the medium of the filter 350 and the director 117 for radiation.

The antenna apparatus 1 according to an embodiment of the present disclosure can achieve more excellent heat dissipation performance because an area occupied by a conventional radome is changed into a heat dissipation area instead of removing the radome.

Heat that is generated toward the rear surface of the main board 310 on the basis of the main board 310 and heat that is generated toward a rear surface of the PSU unit 400 can be brought into direct surface thermal-contact with the rear heat dissipation housing 200 and rapidly discharged backward by using the plurality of heat dissipation pins 201 that are integrally formed in the rear heat dissipation housing 200.

In this case, heat that is collected by the clamshell in the space between the filter 350 and the main board 310 can be discharged backward by using the rear heat dissipation housing 200 as a heat transfer medium through the filter assembly protrusion 357 of the filter 350 and the heat discharge via holes 357a of the main board 310.

As described above, the antenna apparatus 1 according to an embodiment of the present disclosure has effects in that system heat within the antenna apparatus 1 can be discharged in all directions including the front thereof in addition to the rear thereof by the area of the front heat dissipation housing 100, which is increased due to the removal of the radome, and heat dissipation performance is greatly improved because the antenna module 110 is disposed in the front heat dissipation housing 100 of the antenna apparatus 1, but is disposed to be exposed to outside air so that heat can be discharged to the front and rear of the antenna apparatus 1.

The antenna apparatus according to an embodiment of the present disclosure has been described above in detail with reference to the accompanying drawings. However, an embodiment of the present disclosure is not essentially limited to the aforementioned embodiment, and may include various modifications and implementations within an equivalent range thereof by a person having ordinary knowledge in the art to which the present disclosure pertains. Accordingly, the true range of a right of the present disclosure will be said to be defined by the appended claims.

### INDUSTRIAL APPLICABILITY

The present disclosure provides the antenna apparatus having greatly improved heat dissipation performance because the radome is removed and the radiation element is disposed in the front housing of the antenna apparatus so that both the front housing and rear housing of the antenna apparatus are used in forward and backward heat dissipation.

1. An antenna apparatus comprising:
a front heat dissipation housing in which two or more antenna arrangement parts in each of which one or more radiation elements are disposed on a front surface thereof are continuously arranged in a horizontal direction (H direction); and
a rear heat dissipation housing having a front end to which the front heat dissipation housing is coupled, and a plurality of rear heat dissipation pins for discharging predetermined heat in the rearward direction,
wherein a plurality of front heat dissipation pins that discharge predetermined heat in the forward direction are integrally provided in the front heat dissipation housing, and
some of the plurality of front heat dissipation pins are provided in a form of at least one partition wall that partitions the two or more antenna arrangement parts in the H direction.

2. The antenna apparatus of claim 1, wherein a front end of the at least one partition wall is provided to protrude identically with a front surface of the radiation element from a front surface of the front heat dissipation housing.

3. The antenna apparatus of claim 1, wherein a front end of the at least one partition wall is provided to more forward protrude than a front surface of the radiation element from a front surface of the front heat dissipation housing.

4. The antenna apparatus of claim 2, wherein:
the at least one radiation element is made of a conductive metal material on an antenna patch circuit part that is printed and formed on a printed circuit board for radiation elements, which is disposed in the antenna arrangement part, and is provided in a form of a director for radiation that is electrically connected to the antenna patch circuit part, and
the front end of the at least one partition wall is provided to more protrude than at least a front surface of the director for radiation.

5. The antenna apparatus of claim 1, wherein a plurality of window grooves are incised and formed in the partition wall so that the plurality of window grooves are opened in the H direction.

6. The antenna apparatus of claim 5, wherein the plurality of window grooves are each formed to be adjacent to a left end and right end of each of the radiation elements.

7. The antenna apparatus of claim 6, wherein an incision depth of each of the plurality of window grooves is differently designed by considering isolation performance measurement values with radiation elements that are adjacent to the window groove in the H direction.

8. An antenna apparatus comprising:
a front heat dissipation housing in which two or more antenna modules are continuously arranged in a horizontal direction (H direction),
wherein a plurality of front heat dissipation pins that discharge predetermined heat forward are integrally provided in the front heat dissipation housing, and
some of the plurality of front heat dissipation pins are provided in a form of at least one partition wall that partitions the two or more antenna modules in the H direction.

9. The antenna apparatus of claim 8, wherein the antenna module comprises:
an antenna patch circuit part printed and formed on a printed circuit board for radiation elements that is disposed in an antenna arrangement part;
an antenna module cover disposed to cover a front surface of the antenna patch circuit part; and
a director for radiation disposed on a front surface of the antenna module cover, made of a conductive metal material, and electrically connected to the antenna patch circuit part,
wherein the at least one partition wall is integrally formed in the front heat dissipation housing so that the at least one partition wall partitions the printed circuit boards for radiation elements, among components of the two or more antenna modules that are disposed to be adjacent to each other in the H direction.

10. The antenna apparatus of claim 9, wherein a plurality of window grooves are formed in the partition wall so that the plurality of window grooves are opened in the H direction.

11. The antenna apparatus of claim 10, wherein the plurality of window grooves are each formed at a portion that is close to both left and right ends of the director for radiation.
